(19) United States
(12) Patent Application Publication
(10) Pub. No.: US 2025/0296891 A1
(43) Pub. Date: Sep. 25, 2025

(54) COMPOSITE ARTICLES COMPRISING A THERMAL PROTECTION STRUCTURE, AND RELATED METHODS

(71) Applicant: Northrop Grumman Systems Corporation, Falls Church, VA (US)

(72) Inventors: Benjamin W. Garcia, Clearfield, UT (US); Jacob M. Ketcham, North Salt Lake, UT (US)

(21) Appl. No.: 18/615,427

(22) Filed: Mar. 25, 2024

(51) Int. Cl. C04B 41/52; C04B 41/45; C04B 41/50; C04B 111/00; C04B 111/20; C04B 111/40

(52) U.S. Cl. CPC C04B 41/522; C04B 41/4582; C04B 41/5031; C04B 41/5035; C04B 2111/00568; C04B 2111/00982; C04B 2111/2038; C04B 2111/40

(57) ABSTRACT

A composite article comprises a body comprising a radial region, a tapered region, and a cavity region. The cavity region comprises a cylindrical shape and an inner diameter of the cylindrical shape decreases between the radial region and the tapered region. A nosecone region is adjacent to the tapered region of the body and at an opposing end of the body to the cavity region. A thermal protection structure is on the body and comprises a base layer, an insulating layer is on the base layer, and an erosion resistant layer is on the insulating layer. The insulating layer exhibits a specific gravity of from about 0.01 to about 1.0. Methods of forming the thermal protection structure and of thermally protecting an article are also disclosed.

### TECHNICAL FIELD

The disclosure relates to the field of thermal protection systems (“TPS”) and, more particularly, to thermal protection structures for use on subsonic, supersonic, transonic, and hypersonic vehicles or in other extreme environments.

### BACKGROUND

Aerospace vehicles, such as aircraft and spacecraft, may have an external protection system to endure launch, in-flight, and space environments. These environments may subject the aerospace vehicle to extreme conditions that may otherwise damage the aerospace vehicle. The aerospace vehicle may be exposed to aerodynamic heat from atmospheric friction generated during launch and flight. For instance, use at extremely high velocities (e.g., subsonic, supersonic, transonic, and hypersonic) may expose the aerospace vehicle to high temperatures due to friction generated by contact with passing fluid (e.g., air). For example, the nose and leading edges of wings on a spacecraft may be exposed to high temperatures during re-entry. To prevent high temperatures from adversely affecting the aerospace vehicle, a thermal protection structure is used to insulate the aerospace vehicle.

A thermal protection system may include a layered structure that includes a passive insulation material, a phase change insulation material, and a material separating the passive insulation material and the phase change insulation material. The passive insulation material and material may be ceramic matrix composite materials separated by the phase change insulation material.

### BRIEF SUMMARY

The following presents a simplified summary to provide a basic understanding of some embodiments of the disclosure. This summary is not an extensive overview, nor is it intended to identify key or critical elements of the embodiments, nor to delineate the scope of the disclosure. Rather, its purpose is merely to present a summary of the disclosure in simplified form to be further described hereafter.

A composite article is disclosed and comprises a body comprising a radial region, a tapered region, and a cavity region. The cavity region comprises a cylindrical shape and an inner diameter of the cylindrical shape decreases between the radial region and the tapered region. A nosecone region is adjacent to the tapered region of the body and at an opposing end of the body to the cavity region. A thermal protection structure is on the body and comprises a base layer, an insulating layer on the base layer, and an erosion resistant layer on the insulating layer. The insulating layer exhibits a specific gravity of from about 0.01 to about 1.0.

In another embodiment, a method of forming a thermal protection structure is disclosed and comprises forming a base layer over a mold, forming an insulating layer over the base layer, forming an erosion resistant layer over the insulating layer, and curing the base layer, the insulating layer, and the erosion resistant layer. The insulating layer exhibits a specific gravity of from about 0.01 to about 1.0 and the insulating layer comprises a ceramic foam.

In another embodiment, a method of thermally protecting an article is disclosed and comprises forming a base layer over a mold, forming an insulating layer over the base layer, forming an erosion resistant layer over the insulating layer, curing the base layer, the insulating layer, and the erosion resistant layer, and removing the mold to form a thermal protection structure. The thermal protection structure comprises the base layer, the insulating layer, and the erosion resistant layer. The thermal protection structure also comprises a radial region, a tapered region, and a cavity region that is defined by a surface of the base layer. An inner diameter of the cavity region decreases between the radial region and the tapered region of the thermal protection structure. The thermal protection structure is coupled to an article.

The features, functions, and advantages that have been discussed can be achieved independently in various implementations or may be combined in yet other implementations further details of which can be seen with reference to the following description and drawings.

### BRIEF DESCRIPTION OF THE DRAWINGS

For a detailed understanding of the disclosure, reference should be made to the following detailed description, taken in conjunction with the accompanying drawings, in which like elements have generally been designated with like numerals, and wherein:

FIG. 1 is a perspective view of a thermal protection structure according to embodiments of the disclosure;

FIG. 2 is a perspective view of a composite article including the thermal protection structure according to embodiments of the disclosure;

FIG. 3 is a cross-sectional view of the composite article of FIG. 2 along an axial direction;

FIG. 4 is a perspective cross-sectional view of the composite article during fabrication;

FIG. 5 is a perspective cross-sectional view of the composite article during fabrication;

FIG. 6 is a perspective cross-sectional view of the composite article during fabrication;

FIG. 7A is a perspective view of embodiments of the composite article during fabrication;

FIG. 7B is a perspective view of the composite article during fabrication;

### DETAILED DESCRIPTION

The illustrations presented herein are not actual views of any thermal protection structure, composite article, or any component thereof, but are merely idealized representations, which are employed to describe embodiments of the invention.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any thermal protection structure when utilized in a conventional manner. Furthermore, these terms may refer to an orientation of elements of any thermal protection structure as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

A thermal protection structure is disclosed and includes a base layer, an insulating layer, and an erosion resistant layer. The thermal protection structure may be used in a body of an aerospace structure configured for flight. By way of example only, the aerospace structure may be a vehicle, such as an aircraft or a spacecraft. As used herein, the term “aircraft” may mean and include a vehicle, or a device, designed for travel or operation inside the Earth's atmosphere. As used herein, the term “spacecraft” may mean and include a vehicle, or a device, designed for travel or operation outside the Earth's atmosphere. The aerospace structure may include, but is not limited to, a satellite, a missile, including a Ground Based Strategic Deterrent (GBSD), a Ground Based Midcourse Defense (GMD) system, an Exoatmospheric Kill Vehicle (EKV), or other movable or stationary structures.

As used herein, the term “aerospace structure” is used to collectively refer to aircraft, spacecraft, satellite, missiles, or other movable or stationary structures for use inside the Earth's atmosphere and/or outside the Earth's atmosphere. The thermal protection structure may protect the aerospace structure from an extreme environment (e.g., an extreme temperature environment, an extreme pressure environment, an extreme velocity environment).

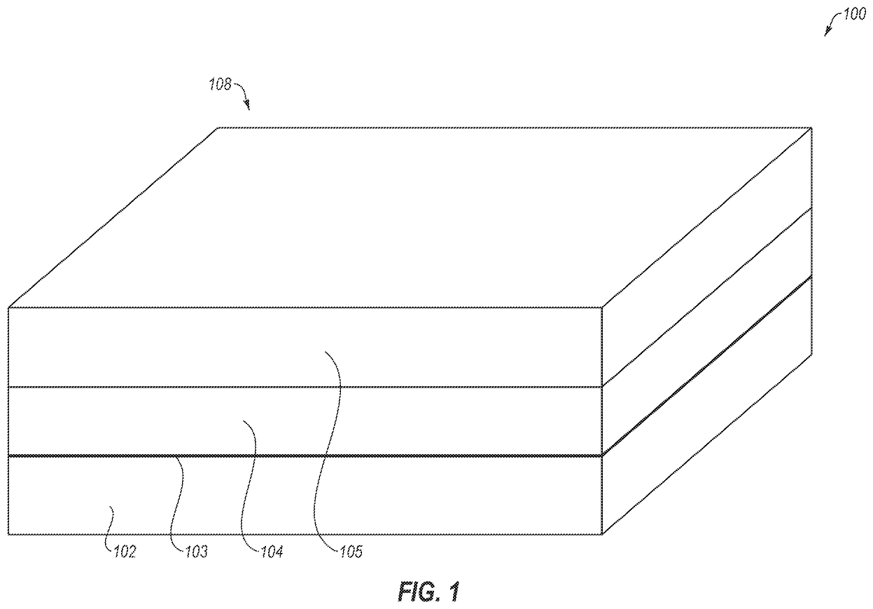

With reference to FIG. 1, a thermal protection structure 100 may be a composite structure that includes a base layer 102, an insulating layer 104, and an erosion resistant layer 105. The erosion resistant layer 105 may be exposed to the extreme environment (e.g., the extreme temperature environment, the extreme pressure environment, the extreme velocity environment) and may include a surface 108 that is in contact with (e.g., exposed to) the environment. The thermal protection structure 100 may optionally include an adhesive 103 between the base layer 102 and the insulating layer 104. Although FIG. 1 illustrates the adhesive 103, the adhesive 103 may not be present. The thermal protection structure 100 may, for example, provide temperature resistance to the aerospace structure when exposed to a temperature greater than or equal to about 1000° C. or to a temperature experienced when the aerospace structure is moving at a high velocity, such as at or above a supersonic velocity or at or above a hypersonic velocity. The aerospace structure may be moving at a velocity of greater than or equal to about Mach 1.5, greater than or equal to about Mach 2, or greater than or equal to about Mach 5. For instance, the thermal protection structure 100 may provide protection to the aerospace structure traveling at a velocity of from about 343 m/s to about 3430 m/s, such as from about 680 m/s to about 2600 m/s, from about 1000 m/s to about 2500 m/s, or from about 1500 m/s to about 2250 m/s. The erosion resistant layer 105 is non-ablative and provides thermal protection to the aerospace structure, while the base layer 102 and the insulating layer 104 provide mechanical properties (e.g., mechanical strength) to the thermal protection structure 100.

Materials used in the layers of the thermal protection structure 100 may be tailored depending on the environment in which the aerospace structure is to be used. The thermal protection structure 100 may also reduce stress and load requirements in the aerospace structure depending on the environment in which the aerospace structure is to be used. While each layer of the thermal protection structure 100 has been described with regard to a primary or individual protective function, the thermal protection structure 100 as a whole may be configured to protect the aerospace structure against damage caused by exposure to extreme environments.

The material of the base layer 102 is selected to exhibit a low moisture uptake (e.g., substantially no water absorption), a glass transition temperature that is higher than an operating temperature to which the thermal protection structure 100 is exposed (e.g., the extreme environment), and is electrically insulating. The material of the base layer 102 may be, for example, a resin material. The resin material may be a solid or liquid phase resin. The base layer 102 may include a liquid phase or filament material. The resin material of the base layer 102 may have any curing mechanism known in the art such as chemical curing, thermal curing, or ultraviolet initiation. If the base layer 102 is a thermal curing material, the cure temperature may be from about 150° C. to about 250° C., such as from about 160° C. to about 220° C., from about 165° C. to about 200° C. The base layer 102 may, for example, be a thermo-curing resin containing OCN groups. In some embodiments, the base layer 102 is a thermo-curing, cyanate ester resin. Non-limiting examples of the base layer 102 may include, but are not limited to, bisphenol M cyanate ester, dicyclopentadienyl bisphenol cyanate ester, bisphenol A cyanate ester, tetramethyl bisphenol F cyanate ester, bisphenol E cyanate ester, hexafluoro bisphenol A cyanate ester, phenol novolac cyanate ester, or phenol novolac cyanate ester. The cyanate ester resin may be cured using a transition metal catalyst including cobalt, copper, manganese, zinc, or a combination thereof. The curing temperature may be substantially the same if the base layer 102 is a liquid phase or a filament material.

The optional adhesive 103 may attach (e.g., bond) the insulating layer 104 to the base layer 102. The adhesive 103, when present, is disposed between the insulating layer 104 and the base layer 102. The adhesive 103 may be formulated to securely attach the insulating layer 104 and the base layer 102 at high temperatures.

The adhesive 103 may be an epoxy-based ceramic, a silicone-based ceramic, a cyanoacrylate-based ceramic, a polyimide-based ceramic, an epoxy resin, or a ceramic based material. The adhesive 103 may have a curing mechanism that is similar to the base layer 102. For example, the adhesive 103 may be cured by thermal, ultraviolet light exposure, a catalyst, or other initiator material. The adhesive 103 may have an operating temperature of from about 55° C. to about 290° C. In some embodiments, the adhesive 103 is a polyimide-based resin. The adhesive 103 may cure through a condensation reaction. The adhesive 103, if present, may maintain strength (e.g., tensile strength, shear strength) at a high operating temperature (e.g., greater than or equal to about 290° C.). Some non-limiting examples of tensile strength of the adhesive 103 may be in a range of from about 2 MPa to about 25 MPa. As a non-limiting example, the adhesive 103 may be a resin such as FM®-57, which is commercially available from Jaco, Boeing Distribution Services, Solvay, or Cytec.

The insulating layer 104 is formulated to prevent or substantially reduce damage to underlying layers of the thermal protection structure 100 that do not exhibit relatively high melting temperatures (i.e., when compared to the insulating layer 104). A material of the insulating layer 104 may exhibit a higher porosity than the other layers of the thermal protection structure 100 (i.e., the base layer 102, the erosion resistant layer 105) and accounts for a majority (i.e., greater than about 50%) of the volume of the thermal protection structure 100. The insulating layer 104 may account for from greater than about 50% to about 75% of the volume of the thermal protection structure 100, such as from about 51% to about 70% of the volume, from about 55% to about 65% of the volume, or from about 60% to about 70% of the volume of the thermal protection structure 100. The insulating layer 104 may be a relatively low-density material (when compared with the other layers of the thermal protection structure) that provides high strength and minimal deformation in the extreme environment. The material of the insulating layer 104 may exhibit a low density, such as exhibiting a specific gravity of from about 0.01 to about 1.0, from about 0.05 to about 0.9, from about 0.1 to about 0.85, or from about 0.2 to about 0.8. The insulating layer 104 may also be radiofrequency (RF) transparent and microwave transparent. The insulating layer 104 may be comprised of more than one material (i.e., a composite). The insulating layer 104 may be a low density, ceramic material (e.g., a refractory ceramic material) that is resistant to temperatures in the range of from about 1000° C. to about 1800° C. The insulating layer 104 may include fibers and a binder.

Non-limiting examples of the insulating layer 104 may include refractory materials such as alumina, silica, magnesium, corundum, magnesite, chromite, tungsten, molybdenum, niobium, tantalum, rhenium, or a combination thereof. The refractory materials of the insulating layer 104 may be heated or cured. The insulating layer 104 may be a ceramic foam, such as a silica foam, an alumina foam, a zirconium oxide foam, a carbon foam, or a silica carbide foam. In some embodiments, the insulating layer 104 is an alumina-silica foam.

By way of example only, the insulating layer 104 may include high alpha polycrystalline alumina fibers and high purity inorganic binders, such as silica. For example, the insulating layer 104 may include from about 50% by weight (wt %) to about 95 wt % alumina and from about 5 wt % to about 50 wt % silica, or from about 60 wt % to about 90 wt % alumina and from about 10% to 40% silica. Non-limiting examples of alumina/silica materials include Zircar ZAL-15, Zircar SALI-2, Zircar ZAL-15AA, or Zircar ASH. A non-limiting example of an alumina/zirconia material includes CalixCeramic Solutions zirconium toughened alumina. In some embodiments, the insulating layer 104 is Zircar ZAL-15.

High velocity travel causes high amounts of fluid to travel over the surface of a material subject to these conditions. These conditions may result in erosion of a conventional material. The material of the erosion resistant layer 105 may, however, be an extremely hard or extremely erosion resistant material. Other properties of the erosion resistant layer 105 may include low density, high strength in high temperature environments (e.g., temperatures greater than or equal to about 1200° C.), and minimal deformation at high temperatures. Further, the erosion resistant layer 105 may be RF transparent. The erosion resistant layer 105 may be formed of a single material or of more than one material (i.e., a composite). Such materials may initially comprise a liquid phase when formed in the thermal protection structure 100. The erosion resistant layer 105 may exhibit a thickness of less than or equal to about 1.5 cm (less than or equal to about 15 mm), such as from about 0.1 mm to about 5 mm, from about 0.5 mm to about 5 mm, from about 1 mm to about 5 mm, from about 2 mm to about 5 mm, from about 3 mm to about 5 mm, from about 4 mm to about 5 mm, from about 1 mm to about 4 mm, from about 2 mm to about 4 mm, or from about 3 mm to about 4 mm. As non-limiting examples, the erosion resistant layer 105 may comprise epoxy resin, carbon fiber infused preceramic resin, phenolic resin, a silicone coating, an epoxy glass film, thermally sprayed tungsten carbide, organic silicone, or zirconium chelated phenolic resin. The material used for the erosion resistant layer 105 may be reinforced with a filament. The filament may be a material such as carbon fiber, polycarbonates, glass, long-chain polyamides, or monoxide-based materials. In some embodiments, the erosion resistant layer 105 comprises carbon fiber reinforced preceramic resin.

The thermal protection structure 100 may be formed by forming (e.g., overlying) the base layer 102, the optional adhesive 103, the insulating layer 104, and the erosion resistant layer 105 over one another.

An aerospace structure that includes the thermal protection structure 100 may be formed by conventional techniques. Such aerospace structures may be vehicles, missiles, or other structures which are configured to travel at extremely high velocities, such as hypersonic velocities or supersonic velocities. The aerospace structure may include the thermal protection structure 100 in any portion of the aerospace structure, with the thermal protection structure 100 coupled to a body of the aerospace structure. The thermal protection structure 100 may, for example, be coupled to a portion of the aerospace structure that is exposed to elevated temperatures when travelling at supersonic speeds, hypersonic speeds, or greater speed. The thermal protection structure 100 may be on at least a portion of the aerospace structure. For instance, the thermal protection structure 100 may cover a portion of the body or the thermal protection structure 100 may cover substantially all of the body. The thermal protection structure may be integrated with the body of the aerospace structure.

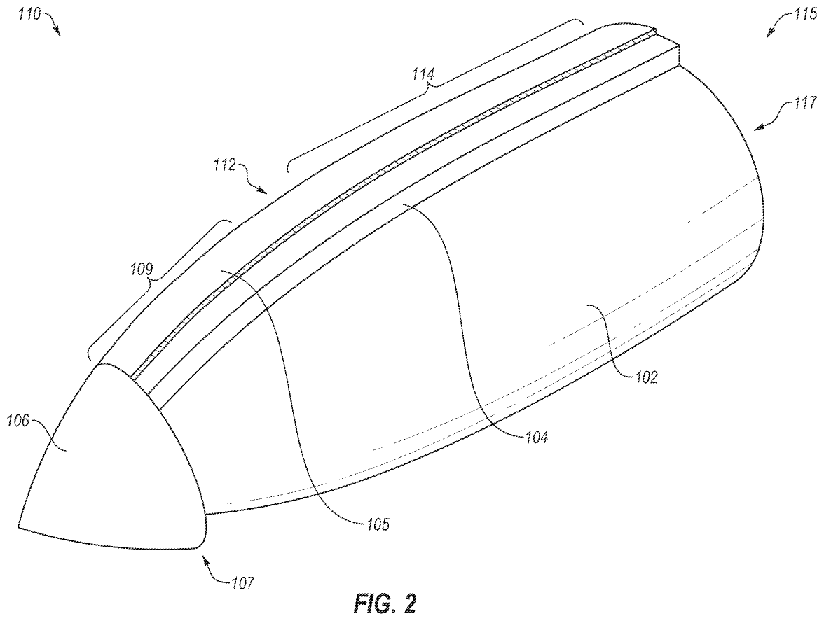

A composite article 110 that includes the thermal protection structure 100 is shown in FIG. 2. The composite article 110 includes a body 112 and a nosecone region 107. The body 112 comprises a radial region 114, a taper region 109, and a cavity region 115. The body 112 may exhibit a substantially cylindrical shape. The nosecone region 107 and the cavity region 115 are on opposite ends of the composite article 110. The body 112 may be formed of and include the base layer 102, the optional adhesive 103, the insulating layer 104, and the erosion resistant layer 105 of the thermal protection structure 100.

The process of forming the composite article 110 defines a cavity 117 on an interior of the composite article 110. The cavity 117 serves as a housing for any material that may be disposed within the composite article 110. The material may be placed within the cavity 117 of the composite article 110 from the cavity region 115 on the opposite side of the nosecone region 107. The cavity 117 may provide a substantially thermally insulated cavity because of the thermal insulating effects of the thermal protection structure 100.

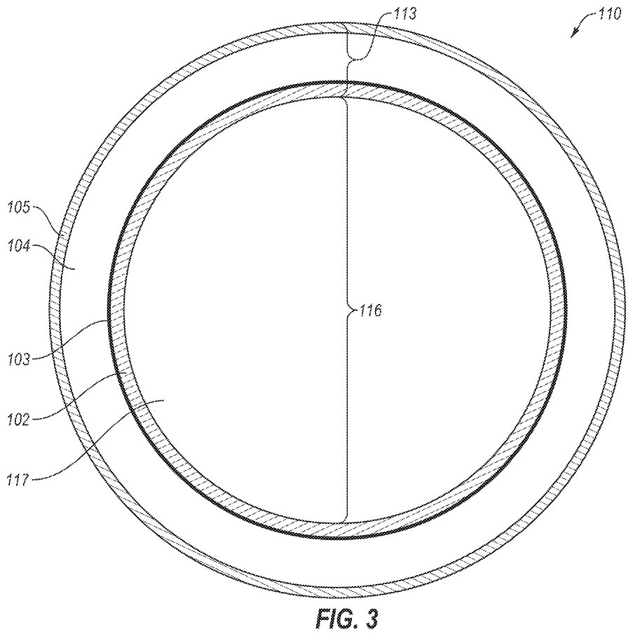

FIG. 3 is a cross sectional view of the composite article 110 showing the cavity 117 in the cavity region 115. A thickness 113 of the thermal protection structure 100 includes a combined thickness of the layers (layers 102, 104, and 105 with 103 being optional). The thickness 113 of the thermal protection structure 100 may be in the range of from about 2.5 cm to about 13.0 cm, such as from about 4.0 cm to about 11.0 cm or from about 4.5 cm to about 10.0 cm, depending on the intended application of the composite article 110. The cavity 117 may comprise the majority (i.e., 50% or more) of the cross-sectional area of the composite article 110. The cavity 117 may have a diameter 116 in a range of from about 1 cm to about 26 cm, such as from about 3 cm to about 16 cm, or from about 4 cm to about 12 cm.

A nosecone 106 disposed in the nosecone region 107 of the composite article 110 may be comprised of different materials than the thermal protection structure 100. The nosecone 106 may be exposed to the highest temperatures of the composite article 110 during use and operation. Accordingly, some characteristics of the nosecone 106 material may be low density, rigidity, high strength, and resistance to erosion. Non-limiting examples of the nosecone 106 material include phenolic resins, aerogels, or carbon-carbon materials, such as carbon phenolic resins, carbon silicone phenolic resins, silica phenolic resins, or reinforced aerogels.

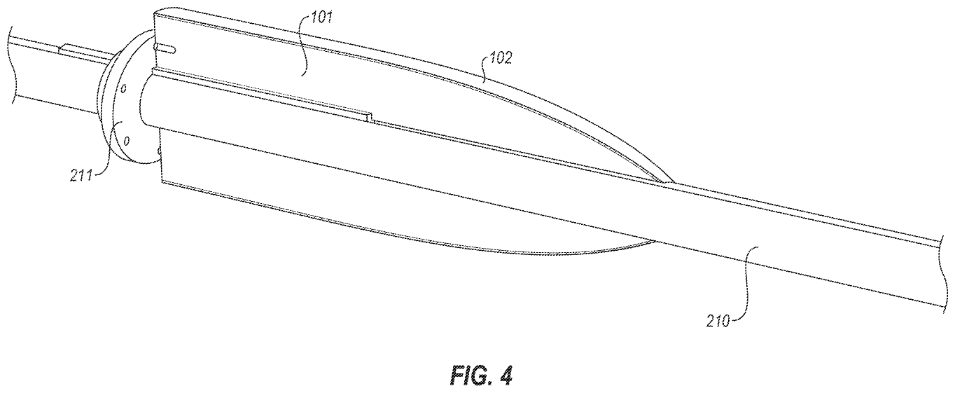

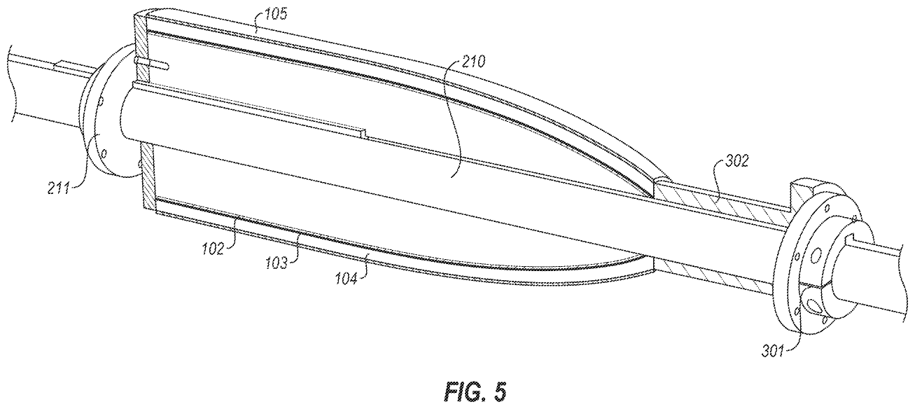

Methods of forming the thermal protection structure 100 and, more particularly, to forming the thermal protection structure 100 of the composite article 110 are shown in FIGS. 4-7B. As shown in FIGS. 4 and 5, the thermal protection structure 100 may be formed by providing (e.g., overlying) each of the respective layers of each of the base layer 102, the optional adhesive 103, the insulating layer 104, and the erosion resistant layer 105 on a mount 101 of the composite article 110. At least a portion of one or more (e.g., all) of the foregoing layers of the thermal protection structure 100 is provided over the mount 101 in an at least partially uncured state (e.g., entirely uncured, partially uncured, a majority uncured) (excluding the insulating layer 104). More particularly, the base layer 102 and the erosion resistant layer 105 may be initially provided in an uncured state. In some embodiments, one or more of the foregoing layers may be provided over the mount 101 by a wet lay-up process. In other embodiments, the layers may be provided by a filament winding process or hand layup.

The mount 101 may be a sacrificial (e.g., temporary) structure upon which the layers of the thermal protection structure 100 are disposed. The mount 101 may be formed to a desired size and shape, such as by additive manufacturing methods, using materials such as acrylonitrile butadiene styrene (ABS), thermoplastic elastomer (TPE), thermoplastic polyurethane (TPU), polylactic acid (PLA), high impact polystyrene (HIPS), nylon, polypropylene, polycarbonate, metal, or wood. The mount 101 may be formed, then mounted onto a winding rod 210, which extends through a radial center of the mount 101, or it may be formed on the winding rod 210 itself. In FIG. 4, the mount 101 may be partially held in place by a securing block 211, which ensures that the mount 101 does not move during manufacturing of the composite article 110.

The base layer 102 may be formed on the mount 101. The manufacturing acts for producing the base layer 102 may depend on whether the material of the base layer 102 is in a solid phase or in a liquid phase. For example, the material of the base layer 102 may be configured as a filament, which is wound in a helical pattern on the mount 101 to form the base layer 102. The base layer 102 may be wound around the mount 101 to a thickness in the range of from about 0.3 cm to about 5 cm, such as from about 4 cm to about 4.8 cm. Alternatively, the material of the base layer 102 may be a liquid, which is evenly distributed over the mount 101 and then cured. The base layer 102 may be formed by a liquid lay-up process including a reinforcing filament.

After winding, pressure may be applied to the base layer 102. Pressure applied to the base layer 102 may be in the range of from about 20 psi to about 40 psi, such as from about 25 psi to about 35 psi. The application of pressure substantially eliminates pores and unwanted material (i.e., water) in the base layer 102. The base layer 102 may be subject to elevated temperatures to cure the material. The temperature applied to the base layer 102 may be in the range of from about 120° C. to about 200° C., such as from about 140° C. to about 190° C., from about 155° C. to about 185° C., or from about 170° C. to about 180° C. The final thickness of the base layer 102 may be less than the thickness of the base layer 102 before the application of pressure and heat. The base layer 102 may, optionally, be machined to form the base layer 102 to a desired shape and configuration. The thickness of the base layer 102 may be in the range of about from about 0.2 cm to about 0.5 cm, such as from about 0.3 cm to about 0.4 cm after the application of pressure and heat.

The adhesive 103, if present, may be applied between the base layer 102 and the insulating layer 104. This adhesive 103 may be applied in the liquid phase and cured with pressure and temperature. The curing of the adhesive 103 may occur after the insulating layer 104 has been formed over the adhesive 103. Alternatively, the base layer 102 may be secured to additional layers without using an adhesive 103. For example, the base layer 102 may be formed on the mount 101 and may remain in a liquid, semi-liquid, semi plastic, or semi solid phase. Other layers may be disposed on top of the base layer 102 and then co-cured, adhering the base layer 102 to subsequent layers disposed thereon, such as the insulating layer 104.

The insulating layer 104 may be formed on the base layer 102 or on the adhesive 103. The insulating layer 104 may be produced by shaping volumes of the material into individual portions, which fit together to form the insulating layer 104. The insulating layer 104 may be formed by attaching the individual portions to the base layer 102 or to the adhesive 103. A pre-ceramic shape is, thus, formed and heated to a temperature between about 900° C. and about 1400° C. The insulating layer 104 is then shaped (e.g., machined) to form the insulating layer 104 to a desired shape and configuration.

The insulating layer 104 may, for example, include multiple portions, such as 2 to 4 separate portions, which are each shaped to form part of the three-dimensional area of the body 112 of the composite article 110. The portions of the insulating layer 104 may be shaped by machining. The portions of the insulating layer 104 may be manufactured using a mold, which is appropriately sized and shaped to produce the portions of the insulating layer 104 at the desired dimensions. The thickness of the insulating layer 104 may be in the range of from about 1 cm to about 10 cm, such as from about 1.5 cm to about 8 cm or from about 2 cm to about 7 cm.

After the portions of the insulating layer 104 are shaped, they are attached to the base layer 102 to form the insulating layer 104 on the base layer 102. The portions may be secured using similar adhesives to the adhesive 103. In FIG. 5, the insulating layer 104 is further secured by securing block 301 and a nosecone region stop 302. The nosecone region stop 302 is placed in contact with the winding rod 210 and the composite article 110. The nosecone region stop 302 and the radial region securing block 211 may prevent the insulating layer 104 from moving during manufacture.

The erosion resistant layer 105 may be disposed on the insulating layer 104 by winding a filament or by spreading a liquid material onto the surface of the insulating layer 104. The following acts of forming the erosion resistant layer 105 being comprised wholly or partly of liquid phase material or filament material may be used in combination or separately. If the erosion resistant layer 105 is a filament, a filament of pre-ceramic resin may be wound in a helical pattern on the surface of the insulating layer 104. The filament may form multiple layers, such as from 6 layers to 10 layers or from 7 layers to 9 layers. The filament layers may exhibit a thickness in the range of from about 0.3 cm to about 0.5 cm, such as from about 0.38 cm to about 0.43 cm. After winding, pressure may be applied to the erosion resistant layer 105. The applied pressure may be in the range of from about 20 psi to about 40 psi, such as from about 25 psi to about 35 psi. The application of pressure substantially eliminates pores and unwanted material (i.e., water) in the material of the erosion resistant layer 105. Heat may be applied to the material of the erosion resistant layer 105. The erosion resistant layer 105 may be substantially uncured, partially cured, substantially cured, or entirely cured. To cure the erosion resistant layer 105, a cure temperature in a range of from about 60° C. to about 150° C. may be used, such as from about 70° C. to about 135° C. or from about 75° C. to about 125° C. The curing time, if the erosion resistant layer 105 is cured, is less than other resins. The curing time may be a maximum of 2 hours. The winding of filament or the spreading of liquid phase resin, with subsequent application of raised temperature and pressure, may be done separately or in combination.

If the erosion resistant layer 105 is a liquid phase material, the material may be evenly distributed over the surface of the insulating layer 104. The liquid phase material may be a ceramic base and may be subjected to pressure and temperature to cure on the surface of the insulating layer 104. The liquid phase material may be reinforced with a high strength filament. By way of example only, carbon fiber may be wound over the insulating layer 104 to reinforce the liquid phase resin material of the erosion resistant layer 105.

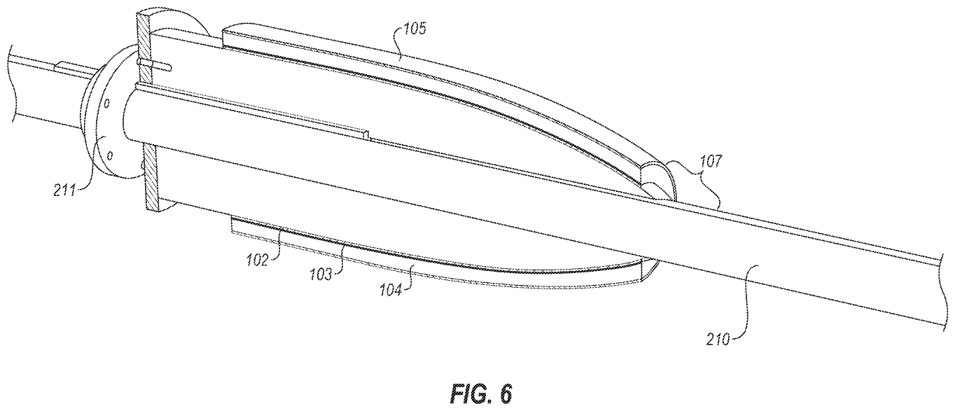

The composite article 110 including the base layer 102, the insulating layer 104, the adhesive 103 (if present), and the erosion resistant layer 105 may be trimmed to a desired length. By way of example only, the composite article 110 may exhibit a length in a range of from about 30 cm to about 60 cm, such as from about 35 cm to about 56 cm, or a from about 41 cm to about 50 cm. The length may be understood as a measurement of the composite article 110 parallel to the winding rod 210, or, parallel to the axial center of the composite article 110. As shown in FIG. 6, the composite article 110 may be trimmed near the securing block 211, with no trimming occurring in the nosecone region 107. The composite article 110 may be removed from the winding rod 210 and the mount 101. After removal, the cavity 117 of the composite article 110 is therefore defined by the base layer 102.

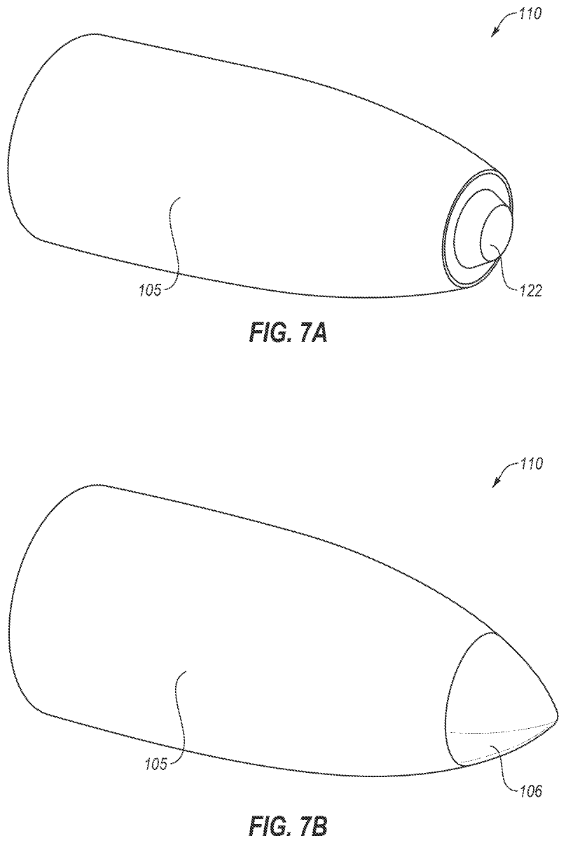

FIG. 7A shows a nosecone mount 122 which may be disposed on the composite article 110 in the nosecone region 107. The nosecone mount 122 may be formed from and include a material that is the same as the material of the base layer 102 or the insulating layer 104, or that is different from the material of the base layer 102 or the insulating layer 104. The nosecone mount 122 may be machined from the material, poured into a mold, or produced through any other manufacturing method. The nosecone mount 122 may be subject to curing processes.

The nosecone mount 122 may be attached to the nosecone region 107 by conventional techniques such as gluing, clamping, or welding. Alternatively, if the material of the nosecone mount 122 is a liquid phase material, the nosecone mount 122 may be manufactured in-situ. Manufacturing the nosecone mount 122 in-situ may include pouring the liquid phase material into a mold which is attached and oriented on the nosecone region 107 in a manner which does not allow any of the liquid phase material to leak or escape the mold. The liquid phase material inside of the mold may be cured. A nosecone 106 is secured to the nosecone mount 122 as shown in FIG. 7B.

Since the nosecone 106 and nosecone region 107 may be exposed to the highest temperatures during use and operation of the composite article 110, insulation (not shown) may optionally be disposed on the nosecone mount 122. The high temperatures within the nosecone region 107 of the composite article 110 may raise the temperature of the nosecone mount 122. This optional insulation may be the same material as the insulating layer 104 or some other material with insulating properties.

Optionally, to mitigate the effects of higher temperatures in the nosecone region 107, the layers of the thermal protection structure 100 of the composite article 110 may not be evenly distributed. Accordingly, the layers of the thermal protection structure 100 (i.e., layers 102, 104, and 105 with optional adhesive 103) may be thicker at a location proximal to the nosecone region 107 of the body 112 (i.e., the taper region 109) such that areas of the body 112 near the nosecone region 107 contain a higher amount of mass when compared to areas of the body 112 near the cavity region 115. This method of mass distribution may be used in combination with the nosecone mount 122 or separately.

The nosecone 106 may be disposed on the nosecone mount 122 in the nosecone region 107, as shown in FIG. 7B and FIG. 2. The nosecone 106 may be secured by the nosecone mount 122 with the nosecone insulating material being optionally disposed therein. The nosecone 106 may be secured by conventional techniques. The nosecone 106 may be manufactured by machining of a material of the nosecone 106, die casting, or some other manufacturing method known in the art.

The manufacturing acts and materials of the base layer 102, insulating layer 104, and erosion resistant layer 105 provide advantages to the resulting thermal protection structure 100 and the composite article 110. The base layer 102 provides strength and structure to the thermal protection structure 100 and composite article 110 while contributing a very low thickness to the composite article 110. The low thickness of the base layer 102 ensures that it does not contribute a large amount of weight to the thermal protection structure 100. The optional adhesive 103 provides cost savings to the manufacturing acts of the composite article 110 and thermal protection structure 100. As described above, the base layer 102 may be optionally left uncured until the insulating layer 104 is disposed in contact with the base layer 102. Curing the base layer 102 while it is in contact with the insulating layer 104 reduces labor costs because applying the adhesive 103 may be omitted. Using the base layer 102 as an adhesive may result in a stronger bond between the base layer 102 and the insulating layer 104 than if the adhesive 103 is used.

Additional benefits may be provided by the insulating layer 104. For example, the insulating layer 104 provides desired material properties while not contributing a large amount of weight to the composite article 110 and the thermal protection structure 100. The insulating layer 104 substantially limits heat transfer from the erosion resistant layer 105 to the base layer 102 and to the cavity 117. The insulating layer 104 is also low in material cost.

Additional benefits of the erosion resistant layer 105 include that the erosion resistant layer 105 is optionally cured or partially cured. Furthermore, thermal processing acts of the erosion resistant layer 105 are not utilized in order for the erosion resistant layer 105 to provide substantial benefits. The benefits that the erosion resistant layer 105 provides to the thermal protection structure 100 and the composite article 110 are low material cost, low production cost, ablation protection, and consistent properties at high temperature. The reduced labor and material costs may result in high volume production of the thermal protection structure 100 and the composite article 110.

During use and operation of the composite article 110, the thermal protection structure 100 may enable various portions of the composite article 110 to be exposed to different temperatures without experiencing damage. The composite article 110 may be exposed to a temperature in the range of from about 150° C. to about 2500° C., such as from about 300° C. to about 2000° C. or from about 400° C. to about 1200° C.

The thermal protection structure 100 according to embodiments of the disclosure may be used in any portion of the aerospace structure that has the capability of travelling at subsonic, transonic, supersonic, or hypersonic speeds (i.e., Mach 1 to Mach 8) or that is otherwise exposed to an extreme temperature or extreme velocity environment. The thermal protection structure 100 may be used to protect the aerospace structure from reentry conditions. The thermal protection structure 100 may be bonded to, attached to, or included in the aerospace structure, providing protection to humans or other mammals in the aerospace structure or to payload or cargo in the aerospace structure.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A composite article, comprising:
a body comprising a radial region, a tapered region, and a cavity region, the cavity region comprising a cylindrical shape and an inner diameter of the cylindrical shape decreasing between the radial region and the tapered region;
a nosecone region adjacent to the tapered region of the body and at an opposing end of the body to the cavity region; and
a thermal protection structure on the body, the thermal protection structure comprising:
a base layer;
an insulating layer exhibiting a specific gravity of from about 0.01 to about 1.0 on the base layer; and
an erosion resistant layer on the insulating layer.

2. The composite article of claim 1, wherein the specific gravity of the insulating layer is from about 0.2 to about 0.8.

3. The composite article of claim 1, wherein the insulating layer exhibits a higher porosity than the base layer and the erosion resistant layer of the thermal protection structure.

4. The composite article of claim 1, wherein the insulating layer accounts for a majority of a volume of the thermal protection structure.

5. The composite article of claim 1, wherein the insulating layer comprises one or more of a radiofrequency transparent material and a microwave transparent material.

6. The composite article of claim 1, wherein the insulating layer comprises a refractory ceramic material.

7. The composite article of claim 1, wherein the insulating layer comprises a ceramic foam.

8. The composite article of claim 1, wherein a thickness of the erosion resistant layer is less than or equal to about 1.5 cm.

9. The composite article of claim 1, further comprising an adhesive between the base layer and the insulating layer.

10. The composite article of claim 1, wherein the cavity region comprises a majority of a cross-sectional area of the composite article.

11. A method of forming a thermal protection structure, comprising;
forming a base layer over a mold;
forming an insulating layer over the base layer, the insulating layer comprising a ceramic foam and exhibiting a specific gravity of from about 0.01 to about 1.0;
forming an erosion resistant layer over the insulating layer; and
curing the base layer, the insulating layer, and the erosion resistant layer.

12. The method of claim 11, wherein forming an insulating layer over the base layer comprises forming one or more portions of an insulating material and placing each portion of the one or more portions of the insulating material in contact with the base layer.

13. The method of claim 12, wherein forming a base layer over a mold and forming an insulating layer over the base layer comprises winding a filament of a base layer material over the mold and applying the one or more portions of the insulating material to the base layer.

14. The method of claim 11, wherein forming an insulating layer over the base layer comprises forming the insulating layer comprising from about 50% by weight to about 95% by weight of alumina and from about 5% by weight to about 50% by weight of silica.

15. The method of claim 11, wherein forming an erosion resistant layer over the insulating layer comprises winding a filament of an erosion resistant layer material over the insulating layer.

16. The method of claim 11, further comprising applying an adhesive to the base layer.

17. A method of thermally protecting an article, comprising;
forming a base layer over a mold;
forming an insulating layer over the base layer;
forming an erosion resistant layer over the insulating layer;
curing the base layer, the insulating layer, and the erosion resistant layer;
removing the mold to form a thermal protection structure comprising the base layer, the insulating layer, and the erosion resistant layer and comprising a radial region, a tapered region, and a cavity region defined by a surface of the base layer, an inner diameter of the cavity region decreasing between the radial region and the tapered region of the thermal protection structure; and
coupling the thermal protection structure to an article.

18. The method of claim 17, wherein coupling the thermal protection structure to an article comprises attaching the thermal protection structure to a body of an aerospace structure.

19. The method of claim 18, wherein attaching the thermal protection structure to a body of an aerospace structure comprises attaching the thermal protection structure to a nosecone region of the aerospace structure.

20. The method of claim 19, wherein attaching the thermal protection structure to a nosecone region of the aerospace structure comprises attaching the thermal protection structure exhibiting a relatively greater thickness proximal to the nosecone region than distal to the nosecone region.
